(19) United States
(12) Patent Application Publication
(10) Pub. No.: US 2026/0228731 A1
(43) Pub. Date: Aug. 6, 2026

(54) VARIABLE CROSS PLATFORM INTERACTION CONTINUITY

(71) Applicant: Visa International Service Association, San Francisco, CA (US)

(72) Inventor: Yuexi Chen, Foster City, CA (US)

(73) Assignee: Visa International Service Association, San Francisco, CA (US)

(21) Appl. No.: 19/155,176

(22) PCT Filed: Feb. 8, 2024
(86) PCT No.: PCT/US2024/015038

§ 371 Date: Aug. 8, 2025

Related U.S. Application Data
(60) Provisional application No. 63/484,156, filed on Feb. 9, 2023.

(51) Int. Cl. G06Q 20/40; G06Q 20/38

(52) U.S. Cl. CPC G06Q 20/4014; G06Q 20/3821

(57) ABSTRACT

A method is disclosed. The method includes receiving, from a user device, interaction information associated with an interaction. The interaction information comprises a user device identifier. The server computer stores data relating to a set of user devices of the user. The set of user devices includes the user device. Responsive to receiving the interaction information, the method includes determining that additional data from additional user devices are needed to generate an authorization request message for the interaction. The method further includes determining a subset of the set of user devices that can provide the additional data, and generating an interaction identifier for the interaction, and communicating with the subset of user devices using the interaction identifier to obtain the additional data. The method also comprises generating the authorization request message including the obtained additional data, and transmitting the authorization request message to an authorizing entity computer for authorization.

### CROSS-REFERENCES TO RELATED APPLICATIONS

This application is a PCT application, which claims priority to U.S. Provisional Application No. 63/484,156, filed on Feb. 9, 2023, which is herein incorporated by reference in its entirety.

### BACKGROUND

Most of the interactions that occur today are conducted and completed using a single user device. For example, a user can use a laptop computer conduct an e-commerce transaction on a merchant Website. The merchant Website can authenticate the user using the user's user identifier (ID) and password. The merchant Website can also receive the user's payment credentials (e.g., a primary account number) from the user to conduct the transaction.

The security and user experience of transactions conducted using a single user device could be improved. For example, in a conventional e-commerce transaction, a physical payment card is not used so it can be less secure than physical in-person transactions. The physical payment card has a cryptographic key, which can be used to generate a cryptogram. The cryptogram provides added security to the transaction. The cryptogram can be used by a downstream entity such as an authorizing entity computer to verify that the user conducting the transaction is in possession of the physical payment card that was issued by the authorizing entity operating the authorizing entity computer. In this situation, it would be desirable to provide for the ability to incorporate the cryptogram into the transaction so that the e-commerce transaction could be as secure as a physical in-person transaction.

Some current solutions such as Apple Pay™ require operating system-level support, use a closed ecosystem, and use a close-proximity wireless protocol (e.g., Bluetooth). Such solutions allow a transaction to be started by a user using a Web browser on a Mac™ computer. An iPhone™ or Apple Watch™ can then be prompted to verify the user through a fingerprint scan or a facial scan, and then generate the transaction cryptogram for issuer verification. However, this solution requires that each device have the same operating system. It would be desirable if a multi-user device transaction process did not require all user devices to use the same operating system. It would be also desirable if the solution could be used across many different types of user devices, instead of just user devices in a closed ecosystem.

Embodiments of the disclosure address this problem and other problems individually and collectively.

### BRIEF SUMMARY

One embodiment of the invention includes a method. The method comprises: receiving, by a server computer from a user device operated by a user, interaction information associated with an interaction, wherein the interaction information comprises a user device identifier, and wherein the server computer stores data relating to a set of user devices of the user, the set of user devices including the user device; responsive to receiving the interaction information, determining, by the server computer, that additional data from additional user devices are needed to generate an authorization request message for the interaction; determining, by the server computer, a subset of the set of user devices that can provide the additional data; generating, by the server computer, an interaction identifier for the interaction; communicating, by the server computer, with the subset of user devices using the interaction identifier to obtain the additional data; generating, by the server computer, the authorization request message comprising the obtained additional data; and transmitting, by the server computer, the authorization request message to an authorizing entity computer for authorization.

Another embodiment of the invention includes a server computer comprising: a processor; and a non-transitory computer readable medium, the non-transitory computer readable medium comprises code, executable by the processor, for performing operations comprising: receiving, from a user device operated by a user, interaction information associated with an interaction, wherein the interaction information comprises a user device identifier, and wherein the server computer stores data relating to a set of user devices of the user, the set of user devices including the user device; responsive to receiving the interaction information, determining that additional data from additional user devices are needed to generate an authorization request message for the interaction; determining a subset of the set of user devices that can provide the additional data; generating an interaction identifier for the interaction; communicating with the subset of user devices using the interaction identifier to obtain the additional data; generating the authorization request message comprising the obtained additional data; and transmitting the authorization request message to an authorizing entity computer for authorization

Another embodiment of the invention includes a method comprising: providing, by a user device operated by a user to a server computer, interaction information associated with an interaction, wherein the interaction information comprises a user device identifier, and wherein the server computer stores data relating to a set of user devices of the user, the set of user devices including the user device, and wherein the server computer determines that additional data from additional user devices are needed to generate an authorization request message for the interaction and determines a subset of the set of user devices that can provide the additional data; receiving, by the subset of devices, additional data requests; and providing, by the subset of devices to the server computer, additional data responses comprising the additional data, wherein the server computer generates the authorization request message comprising the obtained additional data and transmits the authorization request message to an authorizing entity computer for authorization.

A better understanding of the nature and advantages of embodiments of the invention may be gained with reference to the following detailed description and accompanying drawings.

### BRIEF DESCRIPTION OF THE DRAWINGS

FIG. 1 shows a system block diagram and an overlaid exemplary process flow according to embodiments of the invention.

FIG. 2 shows a block diagram of a user device according to an embodiment.

FIG. 3 shows a block diagram of a server computer according to an embodiment.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. A user device can be embodied by hardware (e.g., a mobile phone), software (e.g., a browser), or a combination of hardware with software (e.g., a mobile phone executing a specific application). Examples of user devices may include a mobile phone, a smartphone, a card, a payment card (credit card, debit card, or prepaid card), a personal digital assistant (PDA), a laptop computer, a desktop computer, a server computer, a vehicle such as an automobile, a thin client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G, or similar networks), Wi-Fi, Wi-Max, or any other communication medium that may provide access to a network such as the Internet or a private network. In some cases, a user device can be a payment device.

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of mobile communication devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile communication device can function as a payment device (e.g., a mobile communication device can store and be able to transmit payment credentials for a transaction).

“Interaction information” can include information about an interaction. Interaction information identifies information related to the interaction and the type of interaction taking place. An interaction can be a transaction such as a payment transaction, and interaction information for an interaction can be transaction information.

“Access data” may refer to unique information that identifies a user that is associated with the unique information. Authentication data can comprise a payment token, primary account number (PAN), employee badge number, username, social security number, etc.

“Authentication data” may refer to information that proves or shows something to be true, genuine, or valid. Authenticating a user may refer to a process of verifying the identity of the user, e.g., verifying that the user is who they claim to be. Authentication data can comprise passwords, secrets, biometric data, etc. Authentication data can also include data relating to an authentication result.

A “key” may include a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include an encryption key that may be shared openly and publicly. The public key may be designed to be shared and may be configured such that any information encrypted with the public key may only be decrypted using a private key associated with the public key (i.e., a public/private key pair).

A “private key” may include any encryption key that may be protected and secure. A private key may be securely stored at an entity and may be used to decrypt any information that has been encrypted with an associated public key of a public/private key pair associated with the private key.

A “public/private key pair” may refer to a pair of linked cryptographic keys generated by an entity. The public key may be used for public functions such as encrypting a message to send to the entity or for verifying a digital signature which was supposedly made by the entity. The private key, on the other hand may be used for private functions such as decrypting a received message or applying a digital signature. In some embodiments, the public key may be authorized by a body known as a Certification Authority (CA) which stores the public key in a database and distributes it to any other entity which requests it. The private key can typically be kept in a secure storage medium and will usually only be known to the entity. Public and private keys may be in any suitable format, including those based on Rivest-Shamir-Adleman (RSA) or elliptic curve cryptography (ECC).

An “access device” may be any suitable device that provides access to a resource. An access device may be in any suitable form. Some examples of access devices include vending machines, kiosks, POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), and the like. An access device may use any suitable contact or contactless mode of operation to send or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “mobile communication device” may comprise any suitable electronic device that may be transported and operated by a user, which may also optionally provide remote communication capabilities to a network. Examples of remote communication capabilities include using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile communication devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile communication device may comprise any suitable hardware and software for performing such functions, and may also include multiple devices or components (e.g., when a device has remote access to a network by tethering to another device—i.e., using the other device as a modem—both devices taken together may be considered a single mobile communication device).

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “token service computer” can include a system that that services tokens. In some embodiments, a token service computer can facilitate requesting, determining (e.g., generating) and/or issuing tokens, as well as maintaining an established mapping of tokens to primary account numbers (PANs) in a repository (e.g., token vault). In some embodiments, the token service computer may establish a token assurance level for a given token to indicate the confidence level of the token to PAN binding. The token service computer may include or be in communication with a token vault where the generated tokens are stored. The token service computer may support token processing of payment transactions submitted using tokens by de-tokenizing the token to obtain the actual PAN.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

An “application” may be computer code or other data stored on a computer readable medium (e.g., memory element or secure element) that may be executable by a processor to complete a task.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card.

A “digital wallet provider” may include an entity, such as an issuing bank or third party service provider, which issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile communication device or access device.

A method according to an embodiment of the invention includes receiving, from a user device operated by a user, interaction information associated with an interaction. The interaction information comprises a user device identifier. The server computer stores data relating to a set of user devices of the user. The set of user devices includes the user device. Responsive to receiving the interaction information, the method includes determining that additional data from additional user devices are needed to generate an authorization request message for the interaction. The method further includes determining a subset of the set of user devices that can provide the additional data, and generating an interaction identifier for the interaction, and communicating with the subset of user devices using the interaction identifier to obtain the additional data. The method also comprises generating the authorization request message comprising the obtained additional data, and transmitting the authorization request message to an authorizing entity computer for authorization.

In some embodiments, the server computer can determine which one or more user devices of the user are capable of receiving additional data such as access data (e.g., a primary account number or token), cryptographic verification data (e.g., a cryptogram), and authentication data (e.g., a secret, biometric, or a result of an authentication process) of the user to conduct the transaction. The server computer can collect the additional data from multiple user devices and generate a single authorization request message. The server computer can then send the authorization request message to an authorizing entity computer (e.g., an issuer computer) for authorization. In some embodiments, the authorization request message can be sent from the server computer to the authorizing entity computer via a transport computer (e.g., an acquirer computer), a gateway computer, and/or a processing network computer.

In embodiments of the invention, the server computer can advantageously obtain additional data for an interaction from many user devices, because different user devices can have different processing capabilities and/or can provide different types of data that can enhance an interaction such as a transaction. For example, in some cases, transaction initialization may be best implemented in a web browser, a VR/AR device, or a user device with a fast Internet connection to provide the user with a better user interface and user experience, and/or to reduce friction with user. The security of the transaction can be enhanced by a user device that has a secure memory (e.g., a secure element) where the secret keys can be injected and safeguarded, like a chip card, a secure element, or a Trusted Platform Module (TPM). The transaction processing may also be enhanced with a user device that has a biometric sensor (e.g., fingerprint scanner, facial recognition sensor, palm scanner, etc.) for secure and frictionless verification. The transaction completion may be better implemented using a consolidated user data repository (e.g., e-mail account, social network account, financial data account, etc.) for better tracking and user service.

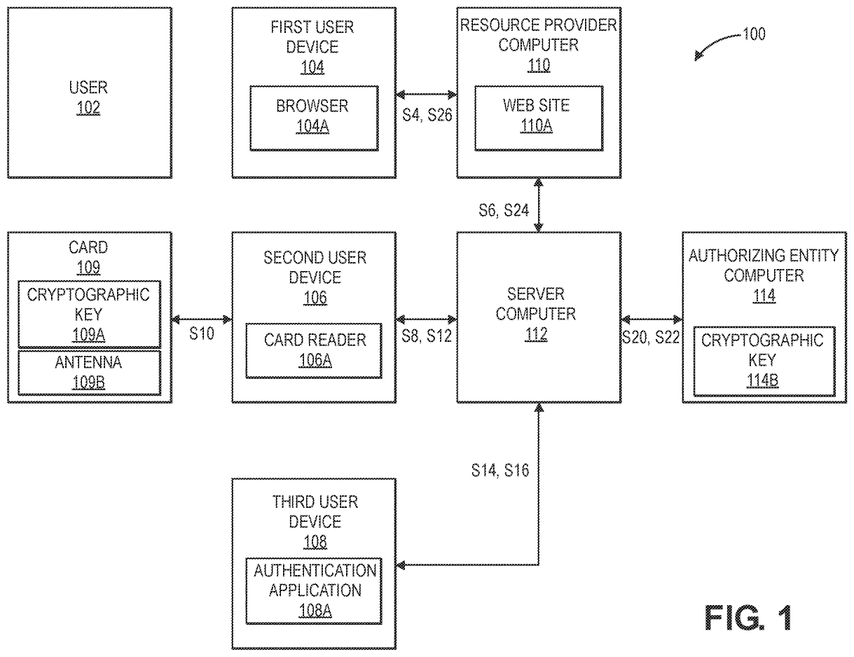

FIG. 1 shows a system block diagram and an overlaid exemplary process flow according to embodiments of the invention. Although FIG. 1 shows a specific number of user devices and computers, embodiments of the invention are not limited thereto. Embodiments can use more or less user devices, and processing computers than are illustrated in FIG. 1.

FIG. 1 shows a user 102 that can own or operate a first user device 104, a second user device 106, and a third user device 108, and a card 109, which may also be an example of a user device. In embodiments of the invention, each of the first user device 104, the second user device 106, the third user device 108, and card 109, can have the same or different operating systems. In embodiments of the invention, at least two of the user devices have different operating systems and/or are produced by different manufacturers. For example, each of the user devices in FIG. 1 can be produced by a different manufacturer, and can each have a different operating system. Also, in embodiments of the invention, each of the first user device 104, the second user device 106, the third user device 108, and card 108, can have the same or different form factor. For example, the first user device 104 can be a laptop computer or tablet computer comprising a browser 104A, the second user device 106 can be mobile phone with a card reader 106A which includes an NFC antenna, and the third user device 108 can be a smart watch which includes an authentication application 108A.

The first user device 104, the second user device 106, and the third user device 108, can each be in communication with a server computer 112. In FIG. 1, the first user device 104 can first communicate with the resource provider computer 110, which in turn can communicate with the server computer 102. The server computer 110 can be a gateway server computer, a digital wallet provider computer, an application service provider computer, etc. The second user device 106 and the third user device 108 can communicate directly with the server computer 112. The resource provider computer 110 can be a Web server that operates a resource provider Web site 110A (e.g., a merchant Web site).

In this example, the card 109 may have been issued by an authorizing entity operating the authorizing entity computer 114. It may include a secure data storage such as a secure memory to store a cryptographic key 109A installed by the authorizing entity. The card 109 can also include an antenna 109B, which can allow it to communicate with the second user device 106 using a contact or short range communication mechanism such as NFC (near field communications).

The server computer 112 can also be in communication with the authorizing entity computer 114. The authorizing entity computer 114 can be operated by an authorizing entity such as an issuer, a governmental agency, or other authority. The authorizing entity computer 114 can store a cryptographic key 114A which corresponds to the cryptographic key 108A on the card 108. The authorizing entity may have issued the card 108 to the user 102. In some cases, the server computer 112 can communicate with the authorizing entity computer 114 via a transport computer (e.g., an acquirer computer operated by an acquirer) and a processing network computer. The acquirer can manage an account of the resource provider operating the resource provider computer 110.

The processing network computer can be a payment processing network, which may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Exemplary methods can be described with respect to FIG. 1 to illustrate embodiments of the invention. Embodiments of the invention are not limited to the specific process flow described therein.

In step S4, the user 102 can initiate an interaction (e.g., a transaction such as a purchase transaction) with the resource provider computer 110 using the first user device 104 to obtain a resource from a resource provider operating the resource provider computer 110. The resource provider computer 110 can operate a Web site 110A such as a merchant Web site. For example, the user 102 can use the browser 104A to communicate with the Web site 110A. In one example, the browser 104A may be using a web browser on a shared or dedicated computer that does not have built-in security features for ensuring that the interaction is secure. The user 102 can select the resources (e.g., goods or services) that they wish to obtain from the resource provider and place them in a virtual shopping cart, and a total for the interaction can be displayed to the user 102. The user 102 can then enter an account identifier (e.g., a primary account number such as a credit or debit card account number) into the Web site 110A and can select a checkout button on a shopping cart to continue with the interaction. The account identifier and an identifier for the first user device 104 and the total amount of the transaction, an identifier for the resource provider operating the resource provider computer 110, and optionally the information about the resources to be obtained by the user 102 can be “interaction information” (e.g., transaction information”) associated with the interaction in this example.

In step S6, the resource provider computer 110 can then transmit the interaction information to the server computer 110, and the server computer 110 can receive the interaction information.

After the server computer 110 receives the interaction information, the server computer 110 can determine that additional data from additional user devices is desirable or needed to generate an authorization request message for the interaction and complete the interaction. For example, the server computer 110 may determine that additional security is needed to complete the transaction. This determination can be based upon the user's or authorizing entity's preferences, or because the transaction amount is high and/or the types of resources being obtained (e.g., gift cards or high value electronics products) may suggest potentially fraudulent activity. Such additional security can be provided by a confirmation that the user 102 conducting the transaction is authentic and is possession of the card 108 which was issued by the authorizing entity operating the authorizing entity computer 114. Additional data such as a cryptogram generated by the card 109, can be used to authenticate the user 102. Other additional data can include using a biometric verification process to determine that the authentic user 102 is the one conducting the transaction. The first user device 104 may not be capable of providing these additional data.

Prior to step S2, the server computer 110 stores data relating to a set of user devices of the user 102. The set of user devices of the user 102 may have been previously registered with the server computer 112 during an enrollment process. Table 1 below, shows examples of user device data for different user devices held or owned by the user 102 that can be stored by the server computer 110.

TABLE 1

| Device | | | Crypto | | |
|---|---|---|---|---|---|
| ID | Device Type | Auth | Key | Connection | Preferred |
| 1a2b3c4d | Laptop Computer | N | N | https://bsfrqOtt.reverse.att.net | |
| | by Company Z | | | | |
| | with Operating | | | | |
| | System by | | | | |
| | Company Z and | | | | |
| | Browser by | | | | |
| | Company A | | | | |
| 5a2b67cd | Tablet by | Y | N | apns://api.push.apple.com: | Y |
| | Company B | | | 443 | |
| | FaceID | | | | |
| 359abdd0 | Laptop | Y | N | wns://cloud.notify.windows.com | |
| | Fingerprint | | | | |
| | Authenticator by | | | | |
| | Company C | | | | |
| 7d00fec3 | Browser by | Y | Y | apns:// | Y |
| | Company D | | | api.push.apple.com:443 | |
| bf4377ad | Phone by | Y | Y | https://11223344.firebaseio.com | Y |
| | Company E using | | | | |
| | Operating | | | | |
| | System A and | | | | |
| | having NFC | | | | |
| | device | | | | |
| ac7f2237 | Watch with | N | Y | https://aabbccdd.firebaseio.com | |
| | Operating | | | | |
| | System B with | | | | |
| | Secure Element | | | | |
| 003342e4 | Contactless Card | N | Y | None | Y |
| | by Authorizing | | | | |
| | Entity A | | | | |

Table 1 shows the following columns of data: user device identifier (“Device ID”), device type (“Device Type”), whether or not the device is capable of authenticating the user (“Auth”), whether the device has a unique cryptographic key such a private key that can be used for authentication (“Crypto Key”), the connection to the user device (“Connection”), and whether or not the user device is preferred by the user (“Preferred”). The server computer 110 may also have a column which stores the current connection status of each user device when the transaction is being processed. The server computer 112 can use the connections to ping each of the user devices to determine if they are currently available. The server computer 112 could also geolocate each user device and store the geolocation of each user device.

The server computer 110 can then determine a subset of the set of user devices that can provide the additional data needed to complete the transaction. The determination of the subset of user devices can based on a number of factors including the type of data required to complete the interaction, the preferences of the user 102, the specific capabilities of the user devices, the expected response times for the user devices, the locations of the user devices, and/or the connection statuses (e.g., manual, offline, online, etc.) of the user devices. In this example, the server computer 112 may have determined that it needs to obtain additional data in the form of a cryptogram that is created using the card 108 and an authentication result of an authentication process authenticating the user 102. The server computer 112 may have determined that the cryptogram can be provided by the contactless card with the device identifier 003342e4 in communication with the NFC Phone bf4377ad. The server computer 112 may have also determined that the authentication result can be obtained from the tablet with the device identifier 5a2b67cd.

Before or after determining the subset of user devices, the server computer 110 can generate an interaction identifier for the interaction (e.g., a transaction identifier for a transaction). The interaction identifier may be independent of any interaction identifier that was created by the resource provider computer 110. The interaction identifier can be any suitable alphanumeric string, and it can be derived (e.g., mathematically derived) from the transaction information or randomly generated. In some embodiments, the interaction identifier can be a unique transaction reference linked to the identity of the user. It can be linked to or associated with a user account ID (e.g., a user ID for a device manufacturer, social network, or digital wallet) or a credential such as a primary account number, or a token of the credential. The interaction identifier can allow the processing of the interaction to be continued on any user device associated with the user 102.

After determining the subset of user devices and the interaction identifier, the server computer can communicate with the subset of the user devices using the interaction identifier to obtain the additional data. Communicating with the subset of the set of user devices can comprise transmitting additional data request messages including the interaction identifier to the selected user devices. Communicating with the subset of the set of user devices can also comprise receiving additional data response messages including the interaction identifier from the user devices.

In step S8, the server computer 112 can transmit an additional data request message comprising the interaction identifier and at least some of the interaction information (e.g., the interaction or transaction amount) to the second user device 108 to request a cryptogram from the second user device 108. The second user device 108 can then prompt the user 102 to present the card 109 to the second user device 106. The second user device 108 may be a phone with an NFC card reader 104A.

In step S10, the second user device 108 can pass the interaction information to the antenna 109A in the card 109 via a short range communication such as NFC. In some embodiments, the card 108 can then obtain a credential (e.g., an account number) stored in its memory and can concatenate it with at least the amount of the interaction. The concatenated value can then be encrypted using the cryptographic key 109A to produce the cryptogram. In some embodiments, the cryptographic key 109A may be a symmetric key that is shared by the authorizing entity computer 114. The card 109 can then pass the cryptogram back to the second user device 106 via the antenna 109A and the card reader 106A.

In step S12, the second user device 106 can generate an additional data response message with the cryptogram and the interaction identifier. After generating the additional data response message, the second user device 106 can transmit it to the server computer 102.

In step S14, before, after, or concurrently with step S8, the server computer 112 can transmit another additional data request message comprising the interaction identifier and a request to authenticate the user 102 to the third user device 108.

After receiving the additional data request message, the third user device 108 can use the authentication application to prompt the user 102 to provide authentication data to authenticate themselves to the third user device 108. In some embodiments, the third user device 108 can store or have access to a previously enrolled biometric (e.g., a face image) or secret (e.g., a PIN) of the user 102. The user 102 can enter the authentication data into the third user device 108, and the third user device 108 can determine if the entered authentication data matches the enrolled authentication data. The third user device 108 can then provide an authentication result (e.g., “authenticated” or “not authenticated”).

In step S16, the third user device 108 can generate an additional data response message with the authentication result and the interaction identifier. After generating the additional data response message, the third user device 108 can transmit it to the server computer 102.

Note that the server computer 112 can communicate with the subset of user devices in any order, and in parallel or sequentially. Further, although two additional user devices are discussed in the method described with respect to FIG. 1, embodiments of the invention can use any number of user devices to complete an interaction.

After receiving the additional data from the second user device 106 and the third user device 108, the server computer 112 can aggregate the interaction information and the additional data using the interaction identifier. The server computer 112 can then generate an authorization request message including at least some of the interaction information received from the resource provider computer 110, and the additional data from the second user device 106 and the third user device 108. For example, the authorization request message may comprise the credential (e.g., primary account number) obtained from the user 102 via the first user device 104, the interaction amount from the resource provider computer 150, the cryptogram from the second user device 106 and the card 108, and the authentication result from the third user device 108.

In step S20, after generating the authorization request message, the authorization request message can be transmitted by the authorizing entity computer 114. The authorizing entity computer 114 can analyze the data in the authorization request message and can determine if the authorization request message should be approved or declined. The authorizing entity computer 114 can determine whether an account associated with the credential has sufficient credit or funds to pay for the interaction amount. The authorizing entity computer 114 can also validate the cryptogram using the corresponding cryptographic key 114B to the cryptographic key 108A and can also evaluate the authentication result.

In some embodiments, a transport computer and a processing network computer may be between the server computer 112 and the authorizing entity computer 114. The transport computer can be an acquirer computer operated by an acquirer that manages an account of the resource provider operating the resource provider computer 110. The processing network computer may be a computer that is operated by a payment processing network.

In step S22, after determining whether to authorize or decline the interaction, the authorizing entity computer 114 can generate an authorization response message and can transmit it to the server computer 112.

In step S24, the server computer 114 can inform the resource provider computer 110 of the authorization result or may forward the authorization response message to the resource provider 110.

In step S26, the resource provider computer 110 can inform the first user device 104 of the authorization result and the approval of the interaction.

At a later time, a clearing and settlement process for the interaction can occur, where funds are transferred from the authorizing entity operating the authorizing entity computer 114 to the resource provider operating the resource provider computer 110.

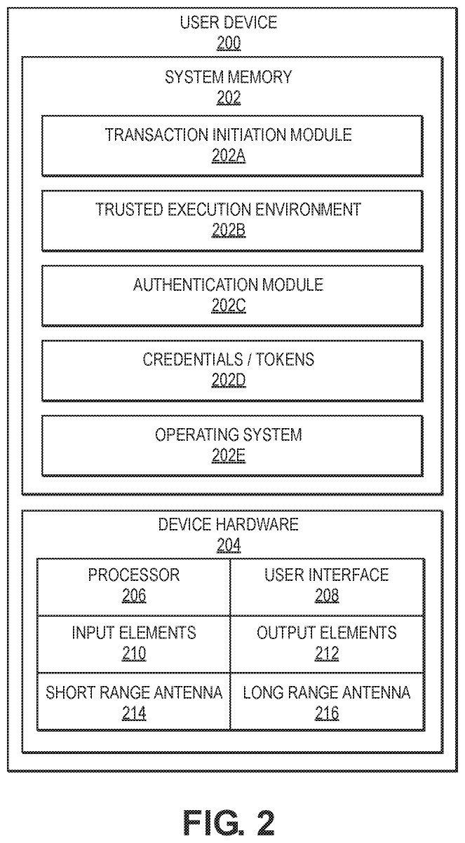

FIG. 2 illustrates a user device 200 according to an embodiment. The user 200 may include device hardware 204 coupled to a system memory 202. The user device 200 can be a communication device such as a mobile phone.

Device hardware 204 may include a processor 206, a short range antenna 214, a long range antenna 216, input elements 210, a user interface 208, and output elements 212 (which may be part of the user interface 208). Examples of input elements may include microphones, keypads, touchscreens, sensors, etc. Examples of output elements may include speakers, display screens, and tactile devices. The processor 206 can be implemented as one or more integrated circuits (e.g., one or more single core or multicore microprocessors and/or microcontrollers), and is used to control the operation of mobile communication device 200. The processor 206 can execute a variety of programs in response to program code or computer-readable code stored in the system memory 202, and can maintain multiple concurrently executing programs or processes.

The long range antenna 216 may include one or more RF transceivers and/or connectors that can be used by mobile communication device 200 to communicate with other devices and/or to connect with external networks. The user interface 208 can include any combination of input and output elements to allow a user to interact with and invoke the functionalities of mobile communication device 200. The short range antenna 214 may be configured to communicate with external entities through a short range communication medium (e.g., using Bluetooth, Wi-Fi, infrared, NFC, etc.). The long range antenna 216 may be configured to communicate with a remote base station and a remote cellular or data network, over the air.

The system memory 202 can be implemented using any combination of any number of non-volatile memories (e.g., flash memory) and volatile memories (e.g., DRAM, SRAM), or any other non-transitory storage medium, or a combination thereof media. The system memory 202 may store computer code, executable by the processor 805, for performing any of the functions described herein.

The system memory 202 may also store a transaction initiation module 202A, a trusted execution environment 202B, an authentication module 202C, credentials 202D, and an operating system 202E, The transaction initiation module 202A may include instructions or code initiating and conducting a transaction with an external device such as an access device or a processing computer. It may include code, executable by the processor 206, for generating and transmitting authorization request messages, as well as receiving and forwarding authorization response messages. It may also include code, executable by the processor 206, for forming a local connection or otherwise interacting with an external access device. The trusted execution environment 202B may comprise code, executable by the processor 206, to perform secure operations such as cryptographic operations. The trusted execution environment 202B can also have a secure memory for storing cryptographic keys. The authentication module 202C may comprise code, executable by the processor 206, to authenticate a user. This can be performed using user secrets (e.g., passwords) or user biometrics.

System memory 202 may also store credentials and/or tokens 202D. Credentials may also include information identifying the mobile communication device 200 and/or the user of the mobile communication device 200. Examples of credentials may include a public key associated with the mobile communication device 200 and/or a user of the mobile communication device 200, a digital signature (e.g., the public key of the mobile communication device 200 signed by a key of the authentication system), payment credentials, biometric data (e.g., biometric samples or templates), etc.

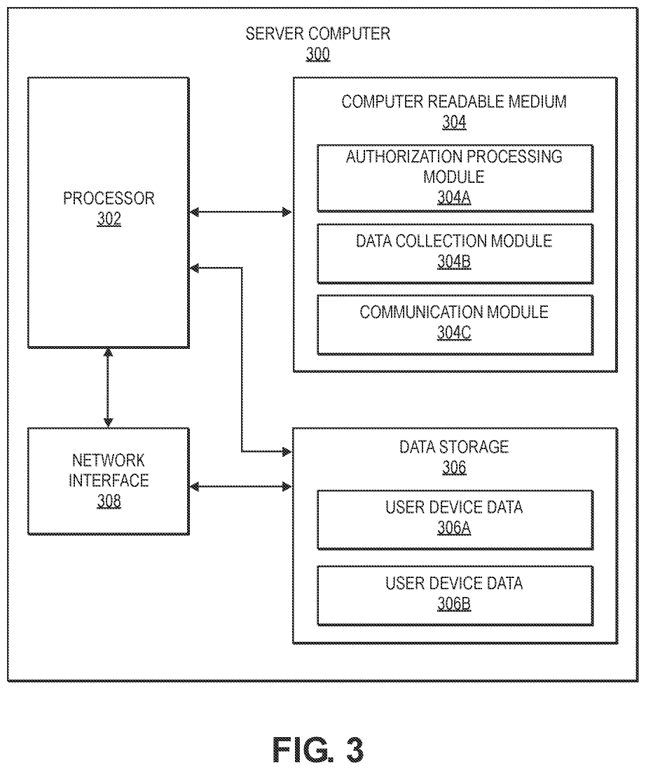

FIG. 3 shows a block diagram of a processing computer 108 according to an embodiment. The processing computer 300 may comprise a processor 302, which may be coupled to a computer readable medium 304, data storage 306, and a network interface 308. The data storage 306 may contain user device data 306A, 306B for various user devices of various users.

The computer readable medium 304 may comprise a number of software modules including an authorization processing module 03A, a data collection module 304B, and a communication module 304C.

The authorization processing module 304A may comprise code that can cause the processor 302 to evaluate authorization request messages for transactions and determine if the transactions should be authorized. The authorization processing module 304A may also include code for routing or modifying authorization request and response messages as they pass between various parties such as authorizing entity computers (e.g., issuer computers) and transport computers (e.g., acquirer computers).

The data collection module 304B and the processor 302 may perform the additional data collection steps described above.

The communication module 304C may comprise code that causes the processor 302 to generate messages, forward messages, reformat messages, and/or otherwise communicate with other entities.

The computer readable medium 304 may also comprise code executable by the processor 302 to perform operations including: receiving, from a user device operated by a user, interaction information associated with an interaction, wherein the interaction information comprises a user device identifier, and wherein the server computer stores data relating to a set of user devices of the user, the set of user devices including the user device; responsive to receiving the interaction information, determining that additional data from additional user devices are needed to generate an authorization request message for the interaction; determining a subset of the set of user devices that can provide the additional data; generating an interaction identifier for the interaction; communicating with the subset of user devices using the interaction identifier to obtain the additional data; generating the authorization request message comprising the obtained additional data; and transmitting the authorization request message to an authorizing entity computer for authorization.

Embodiments of the invention have a number of technical advantages. Embodiments of the invention can utilize multiple user devices to conduct an interaction, where each user device optimally performs a specific function or provides specific data to improve the overall transaction reliability, quality, speed, and/or security. Embodiments of the invention can perform such interactions without the requirement that all user devices operate using the same underlying operating system and without the need for all devices to be in close proximity to each other. The embodiments described herein can be used across operating system platforms (e.g., iOS/Android/Windows/Tizen) and across ecosystems (e.g., Apple™/Google™/Microsoft™/Samsung™).

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a server computer from a user device operated by a user, interaction information associated with an interaction, wherein the interaction information comprises a user device identifier, and wherein the server computer stores data relating to a set of user devices of the user, the set of user devices including the user device;
responsive to receiving the interaction information, determining, by the server computer, that additional data from additional user devices are needed to generate an authorization request message for the interaction;
determining, by the server computer, a subset of the set of user devices that can provide the additional data;
generating, by the server computer, an interaction identifier for the interaction;
communicating, by the server computer, with the subset of the user devices using the interaction identifier to obtain the additional data;
generating, by the server computer, the authorization request message comprising the obtained additional data; and
transmitting, by the server computer, the authorization request message to an authorizing entity computer for authorization.

2. The method of claim 1, wherein the user device is a first user device, the additional data comprises a cryptogram and user authentication data, the set of user devices includes a second user device and a third user device, and wherein the cryptogram is obtained from the second user device and the user authentication data is obtained from the third user device.

3. The method of claim 2, wherein the interaction information comprises identifying information associated with the user.

4. The method of claim 3, wherein the identifying information comprises a credential.

5. The method of claim 4, wherein the authorization request message comprises the credential, the cryptogram, and the user authentication data.

6. The method of claim 1, wherein the data relating to the set of user devices comprises indications of whether or not the user devices can provide certain data types of the additional data and connection addresses for the user devices.

7. The method of claim 6, wherein the data relating to the set of user devices comprises user preferences for the use of the user devices.

8. The method of claim 1, wherein communicating with the subset of the set of user devices comprises transmitting additional data request messages including the interaction identifier and receiving additional data response messages including the interaction identifier.

9. The method of claim 1, wherein at least two user devices in the subset of user devices use different operating systems.

10. The method of claim 1, wherein the user device is a first user device, and the set of user devices includes a second user device and a third user device, and wherein the first user device, the second user device, and the third user device have different form factors.

11. The method of claim 1, wherein the subset of the set of user devices comprises a first user device, a second user device and a third user device, which are different and each of the first user device, the second user device, and the third user device is one of the following types of user devices: a watch, a laptop computer, a card, a mobile phone, a desktop browser, and a mobile phone application.

12. The method of claim 1, further comprising:
receiving, by the server computer, an authorization response message from the authorizing entity computer, the authorization response message being responsive to the authorization request message.

13. The method of claim 1, further comprising:
receiving, by the server computer, the data relating to the set of user devices of the user during a user enrollment process.

14. The method of claim 1, wherein the server computer determines current connection statuses of the user devices in the set of user devices, and wherein the subset of the set of user devices is determined using the current connection statuses.

15. A server computer comprising:
a processor; and
a non-transitory computer readable medium, the non-transitory computer readable medium comprises code, executable by the processor, for performing operations comprising:
receiving, from a user device operated by a user, interaction information associated with an interaction, wherein the interaction information comprises a user device identifier, and wherein the server computer stores data relating to a set of user devices of the user, the set of user devices including the user device;
responsive to receiving the interaction information, determining that additional data from additional user devices are needed to generate an authorization request message for the interaction;
determining a subset of the set of user devices that can provide the additional data;
generating an interaction identifier for the interaction;
communicating with the subset of user devices using the interaction identifier to obtain the additional data;
generating the authorization request message comprising the obtained additional data; and
transmitting the authorization request message to an authorizing entity computer for authorization.

16. The server computer of claim 15, wherein the data relating to the subset of the set of user devices comprises indications of whether or not the user devices can provide certain data types of the additional data and connection addresses for the user devices.

17. A method comprising:
providing, by a user device operated by a user to a server computer, interaction information associated with an interaction, wherein the interaction information comprises a user device identifier, and wherein the server computer stores data relating to a set of user devices of the user, the set of user devices including the user device, and wherein the server computer determines that additional data from additional user devices are needed to generate an authorization request message for the interaction and determines a subset of the set of user devices that can provide the additional data;
receiving, by the subset of the set of user devices, additional data requests; and
providing, by the subset of the set of user devices to the server computer, additional data responses comprising the additional data, wherein the server computer generates the authorization request message comprising the obtained additional data and transmits the authorization request message to an authorizing entity computer for authorization.

18. The method of claim 17, wherein the user device is a first user device, and the set of user devices includes a second user device and a third user device, wherein the first user device, the second user device, and the third user device have different form factors.

19. The method of claim 18, wherein the first user device, the second user device and the third user device are different and are one of the following types of user devices: a watch, a laptop computer, a card, a mobile phone, a desktop browser, and a mobile phone application.

20. The method of claim 17, wherein the interaction is a transaction.
